(19) United States
(12) Patent Application Publication
(10) Pub. No.: US 2017/0245626 A1
(43) Pub. Date: Aug. 31, 2017

(54) CONVERTIBLE BICYCLE BAG

(71) Applicant: B&B BEETLE BAG COMPANY LLC, Culver City, CA (US)

(72) Inventor: Guy Nehmad, Culver City, CA (US)

(73) Assignee: B&B BEETLE BAG COMPANY LLC, Culver City, CA (US)

(21) Appl. No.: 15/514,502

(22) PCT Filed: Sep. 27, 2015
(86) PCT No.: PCT/IB2015/057408

§ 371 Date: Mar. 25, 2017

Related U.S. Application Data
(60) Provisional application No. 62/055,670, filed on Sep. 26, 2014.

(51) Int. Cl. A45F 4/00; B62J 9/00; A45F 3/04

(52) U.S. Cl. CPC A45F 4/00; A45F 3/04; B62J 9/005

(57) ABSTRACT

Disclosed is a bicycle bag suitable to be straddled over a structural tube of a bicycle in a folded position and convertible to a backpack in an open position. The structural tube may include the top-tube or the bottom-tube of the bicycle. There is provided, in accordance with an embodiment of the present invention, a bicycle bag suitable to be straddled over a structural tube of a bicycle in a folded position and convertible to a backpack in an open position.

### RELATED APPLICATIONS

This application claims the benefit of priority from U.S. Provisional Patent Application No. 62/055,670 filed Sep. 26, 2014, the contents of which are incorporated herein by reference in their entirety.

### FIELD AND BACKGROUND OF THE INVENTION

The present invention, in some embodiments thereof, relates to a bicycle bag and, more particularly, but not exclusively, to a convertible bicycle bag and backpack.

Bicycle bags are well known in the art. They come in all sizes and shapes and may be attached to different sections of a bicycle. For example, the bags may be attached to a rear carrier on the bicycle, a front rack fitted onto the front of the bicycle, the bicycle handlebar, the bicycle seat, and the top-tube of the bicycle frame. Generally, the bicycle bags include fasteners which allow the bicycle bag to be attached to, and removed from, the bicycle with relative ease.

Many bicycle bags are built of nylon or other types of synthetic fabrics which are waterproof or water-repellent to resist exposure to rain. Generally, these fabrics are also selected to be lightweight so that the bicycle does not substantially contribute to the weight of the bicycle.

Some bicycle bags are convertible into carrying bags for use by the bicycle rider (user) when not riding the bicycle. An example of such a bag is described by Woolf in U.S. Pat. No. 4,433,802 wherein “A combination back pack and bicycle saddle pack is disclosed, wherein the frame of the back pack is mountable to the bicycle above the rear wheel to serve as a horizontal rack from which two pack bags hang suspended as panniers on opposite sides of the rear wheel. The front end of the pack frame is mounted to the bicycle by quick attachment means adjacent the bicycle seat; the rear end of the frame is supported by a swingably positionable strut which extends upwardly from the rear wheel axle”.

Another example of a bicycle bag convertible into a carrying bag is described by Miller in U.S. Pat. No. 5,071,046 wherein is disclosed “A valise for use primarily with a land vehicle such as a velocipede having an external contour complemental to a bicycle frame defined by an area between the seat, the front fork and the crank area. Fastening instrumentalities extend between the valise and the frame for positive support. The valise readily separates from the velocipede for subsequent transport by the rider apart from the velocipede for security.”

Another example of a bicycle bag convertible into a carrying bag is described by Pager in US Patent Application Publication US 2010/0012696 wherein “The presently disclosed article carrier for bicycles is adapted for the mid-frame area of a variety of bicycle frame types having improved practical characteristics for conveying a variety of articles while having minimal adverse effects on, a bicycle's handling. The carrier may be quickly installed and, removed without the use of tools or brackets by buckling a pair of fastening assemblies between the handlebar stem and seat-post, components common to a majority of bicycle frame types currently in the marketplace. The carrier offers improved accessibility to its cargo both while riding and while stationary due to its positioning on the bicycle and to particular zipper styles. The carrier is also proportioned and adapted to real-world applications with minimal nuisance and optimal utility due to its means of attachment, its volumetric expandability, its various utilitarian pockets and compartments and its adjustability. A planned line of optional accessories are separably connectable to the article carrier by means of a proprietary “click” clip system for which the article carrier is pre-equipped to accept. The carrier along with its cargo and extended line of optional accessories adapts, to being securely locked to an unattended bicycle. Moreover at the user's discretion, the carrier adapts to being borne by its human user either by its integrated handle or over the shoulder by its integrated shoulder strap with due respect paid to both practical and aesthetic considerations”.

### SUMMARY OF THE INVENTION

There is provided, in accordance with an embodiment of the present invention, a bicycle bag suitable to be straddled over a structural tube of a bicycle in a folded position and convertible to a backpack in an open position.

According to an embodiment of the present invention, the bicycle bag includes a first wing section, a second wing section, and an interconnecting central section joining the wing sections.

According to an embodiment of the present invention, at least one of the wing sections includes one or more storage compartments for storing items.

According to an embodiment of the present invention, one or more storage compartments are located on an exterior side of the bicycle bag.

According to an embodiment of the present invention, the bicycle bag includes a clasp to attach a forward section of the bicycle bag to a bicycle stem.

According to an embodiment of the present invention, the clasp is adjustable to allow adjusting a distance of the bag from the stem.

According to an embodiment of the present invention, the bicycle bag includes at least one fastening mechanism to secure an underside of the bicycle bag to the structural tube.

According to an embodiment of the present invention, the fastening mechanism includes at least one fastener strap.

According to an embodiment of the present invention, the fastener strap is elastic.

According to an embodiment of the present invention, the bicycle bag includes slots on an underside of the bicycle bag to accommodate retractable fastening straps.

According to an embodiment of the present invention, the bicycle bag includes at least one storage pocket the central section.

According to an embodiment of the present invention, the at least one storage pocket accommodates any one of a drinking bottle, a mobile phone, and a GPS device.

According to an embodiment of the present invention, the bicycle bag includes two storage pockets on an underside of the bag.

According to an embodiment of the present invention, the storage pockets each accommodate a shoulder strap.

According to an embodiment of the present invention, the bicycle bag includes shoulder straps.

According to an embodiment of the present invention, the structural tube is a top-tube.

According to an embodiment of the present invention, the structural tube is a bottom-tube.

### BRIEF DESCRIPTION OF THE DRAWINGS

Some embodiments of the invention are herein described, by way of example only, with reference to the accompanying drawings. Details shown are for exemplary purposes and serve to provide a discussion of embodiments of the invention. The description and the drawings may be apparent to those skilled in the art how embodiments of the invention may be practiced.

FIG. 1 schematically illustrates a perspective view of an exemplary bicycle bag fitted onto a bicycle, according to an embodiment of the present invention;

FIG. 2 schematically illustrates a top view of the bicycle bag in the folded position, according to an embodiment of the present invention;

FIG. 3 schematically illustrates a bottom view of the bag also in the folded position, according to an embodiment of the present invention;

FIG. 4 schematically illustrates a perspective view of the bicycle bag in the folded position, including storage compartments for storing items, according to an embodiment of the present invention;

FIG. 5 schematically illustrates a view of an upper side of the bicycle bag in the open position, according to an embodiment of the present invention;

FIG. 6 schematically illustrates a view of an underside of the bag in the open position, according to an embodiment of the present invention; and

FIG. 7 schematically illustrates the bicycle bag in an exemplary backpack configuration, according to an embodiment of the present invention.

### DETAILED DESCRIPTION

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

The present invention relates to a convertible bicycle bag suitable to straddle a top-tube of a bicycle frame when in a folded position, and may be converted into a backpack for by a user in an open position. The convertible bicycle bag may also be suitable for straddling a bottom-tube of the bicycle frame and consequently, the description provided herein with respect to the top-tube may equally be applicable to the bottom-tube. The convertible bicycle bag may be used with any type of bicycle, including, for example, touring bicycles, racing bicycles, street bicycles, electric bicycles, mountain bikes, boys' and girls' bicycles, cruising bicycles, professional bicycles, among other types of bicycles. For convenience hereinafter, the convertible bicycle bag may be referred to hereinafter as “bicycle bag” or “bag”.

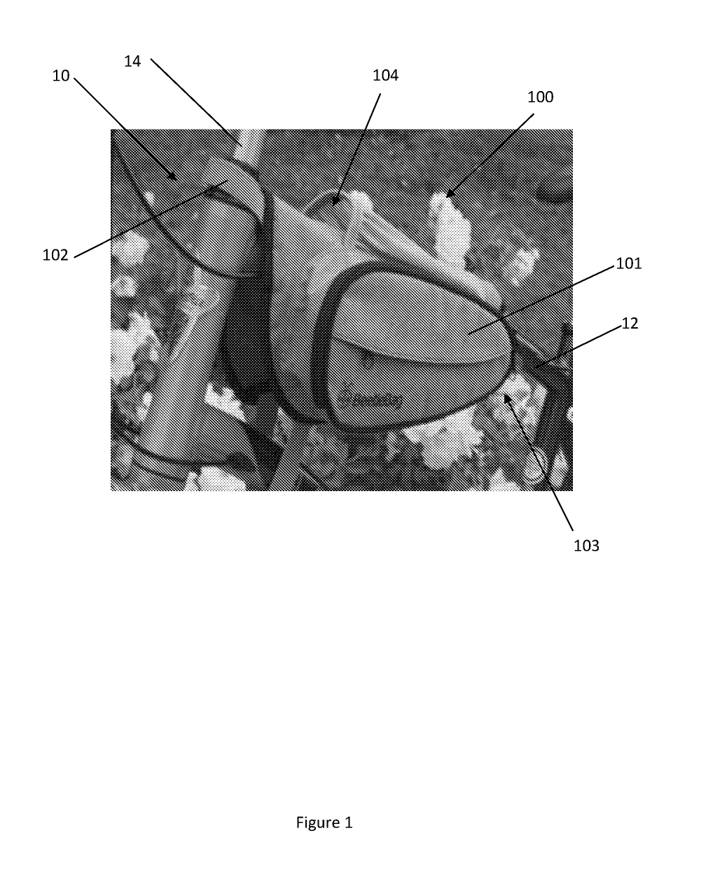

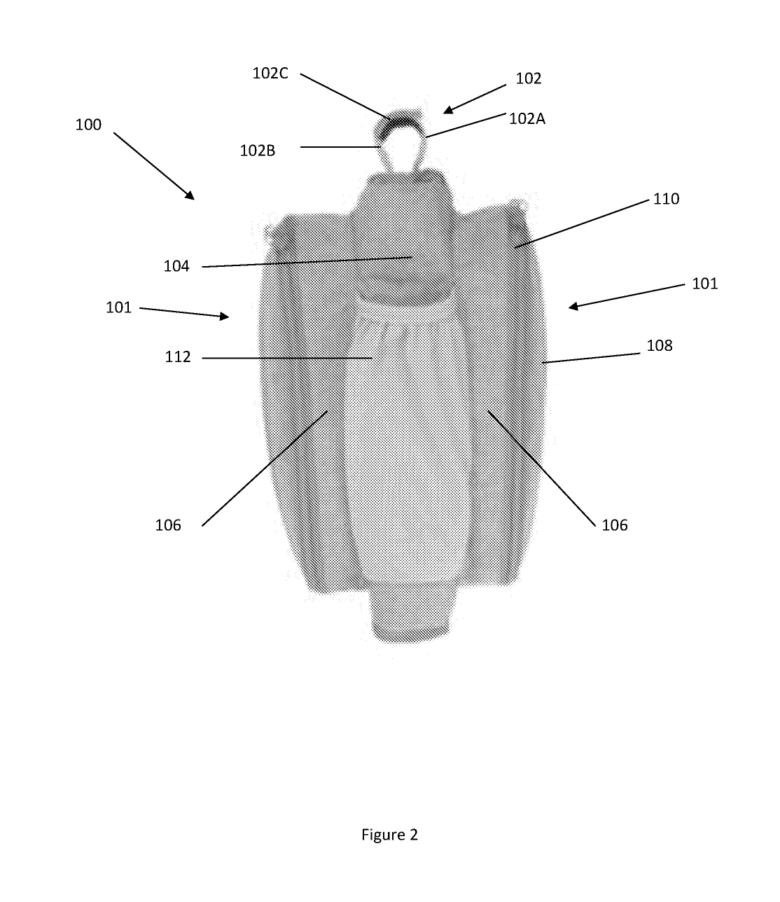

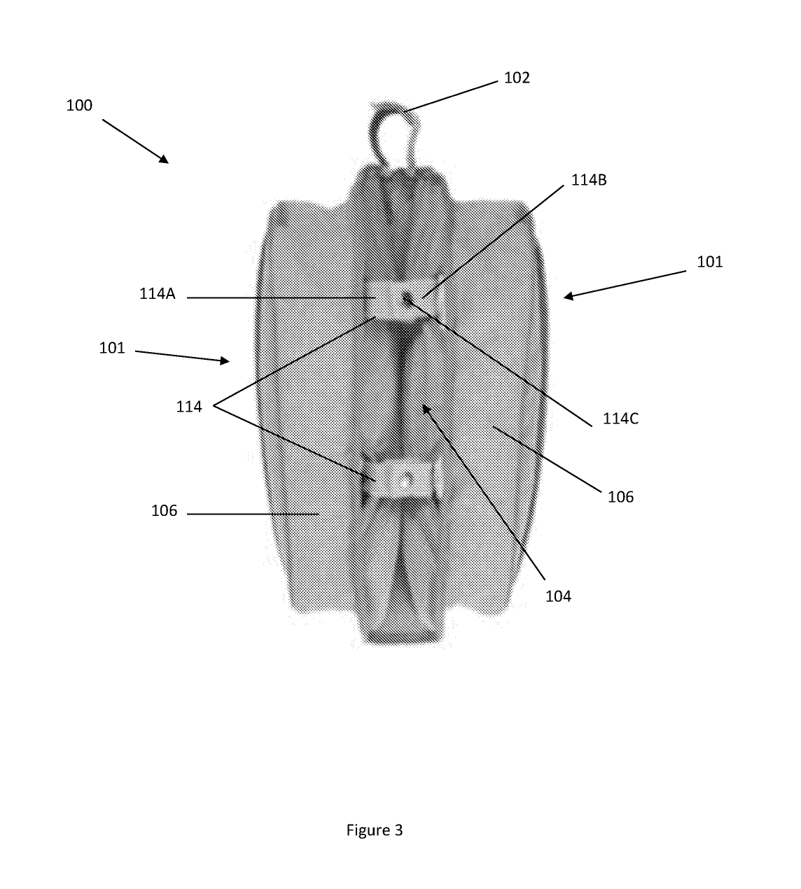

Reference is now made to FIG. 1 which schematically illustrates a perspective view of an exemplary bicycle bag 100 fitted onto a bicycle 10, according to an embodiment of the present invention. As may be appreciated from the figure, bag 100 may be straddled (folded) over a front section of top-tube 12 in bicycle 10 with a forward section of the bag attached to a stem 14 of the bicycle by a front clasp 102 extending from the forward section. Reference is also made to FIG. 2 which schematically illustrates a top view of bicycle bag 100 in the folded position, and to FIG. 3 which schematically illustrates a bottom view of the bag also in the folded position, according to an embodiment of the present invention.

Bicycle bag 100 may include two wing-shaped sections 101 connected together by a central section 104. In the folded position, bag 100 may straddle top-tube 12 supported by central section 104 resting on the top-tube, while the wing-shaped sections hang from the central section on each side of the top-tube opposing one another. In the folded position, bag 100 may have a shape resembling that of a motorcycle gas tank where each wing-shaped section 101 may have a wider forward section and a narrower rear section 103 (the section closest to the rider), potentially improving aerodynamic flow during bicycle travel. This motorcycle gas tank shape may contribute to reducing air-flow resistance. The narrower rear section in wing- shaped section 101 may be additionally designed to not interfere with a pedaling action of the rider. Rear section 103 of each wing-shaped section 101 may additionally be contoured to trace a portion of the translational path of the rider's leg while pedaling, substantially reducing possible collisions of the rider's knee with the bicycle bag.

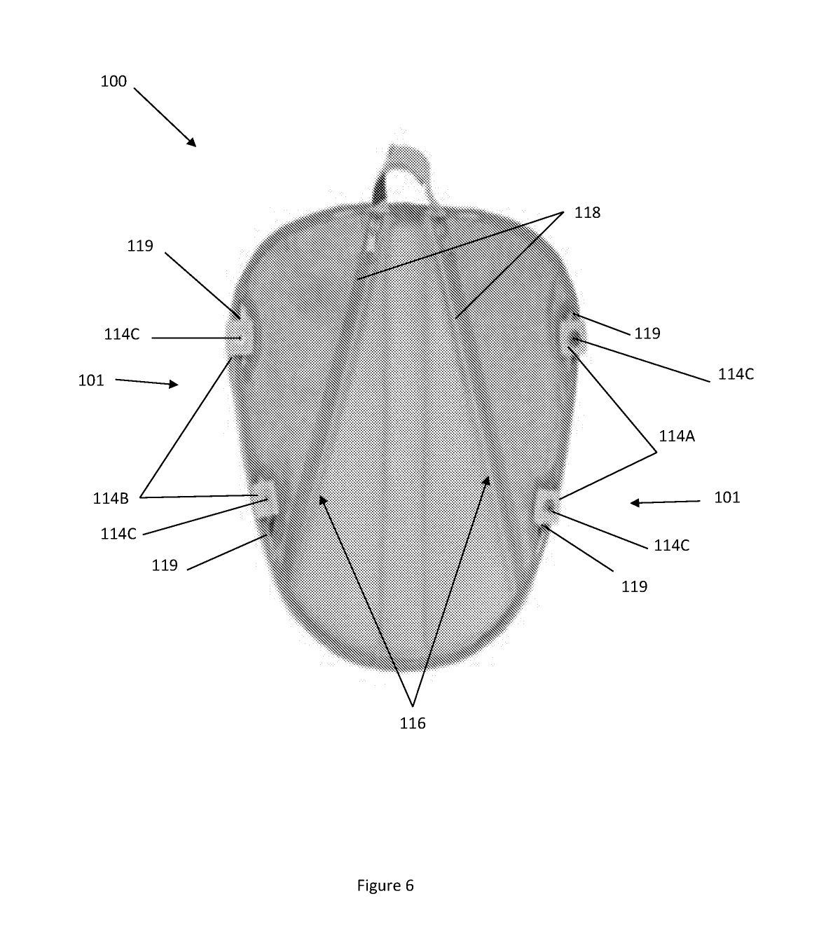

Bicycle bag 100 may include a three point securement mechanism which may allow a rider of the bicycle to secure a position of the bag on top-tube 12 to prevent possible interference with pedaling action, and to restrict possible movement which may potentially interfere with the rider easily accessing storage pockets or items in the bag. The three point securement mechanism may include two or more fastening mechanisms 114 on an underside of bag 100 which may attach hanging wing-shaped sections 101 to one another to prevent movement. Each fastening mechanism 114 may include a first wing strap 114A extending from one wing-shaped section 101 and a second wing strap 114B extending from the second wing-shaped section, with both straps securable to one another. Securement of the wing straps together may include use of a fastener 114C, which may include a clip, a hook and loop fastener, a snap-lock fastener, a buckle fastener, or other suitable fastener known in the art and which may allow rapid release of the straps. Wing straps 114A and 114B may be retractable into slots (as described later on with reference to FIG. 6), and may be made of an elastic material which may allowing applying tension to wing-shaped sections 101 to hold the sections tightly together. It may be appreciated by the skilled person that fastening mechanism 114 may not necessarily require use of wing straps 114A and 114B and that use of a single strap with a fastener 114C, or other fastening solution known in the art, may be sufficient to hold the two wing-shaped sections together in place to provide the necessary securement.

The three point securement mechanism may additionally include front clasp 102 which may engage stem 14, optionally a handlebar of bicycle 10, to prevent slipping of bicycle bag 100 in a rearwards direction towards the rider. Clasp 102 may include a first strap 102A and a second strap 102B which may be attached together by means of a fastener 102C. Fastener 102C may include a hook and loop fastener, a snap-lock fastener or other type of fastener known in the art which may allow rapid attachment and detachment of the clasp to and from stem 14. Clasp 102 may preferably allow adjustment of the distance bag 100 is positioned from stem 14, and therefore, the type of fastener 102C used may be selected accordingly to allow such adjustments. It may be appreciated by the skilled person that clasp 102 may not necessarily require use of straps 102A and 102B and that use of a single strap with a fastener 102C, or other fastening solution known in the art which may also allow adjusting the distance the bag may be positioned from stem 14, may also provide an adequate solution.

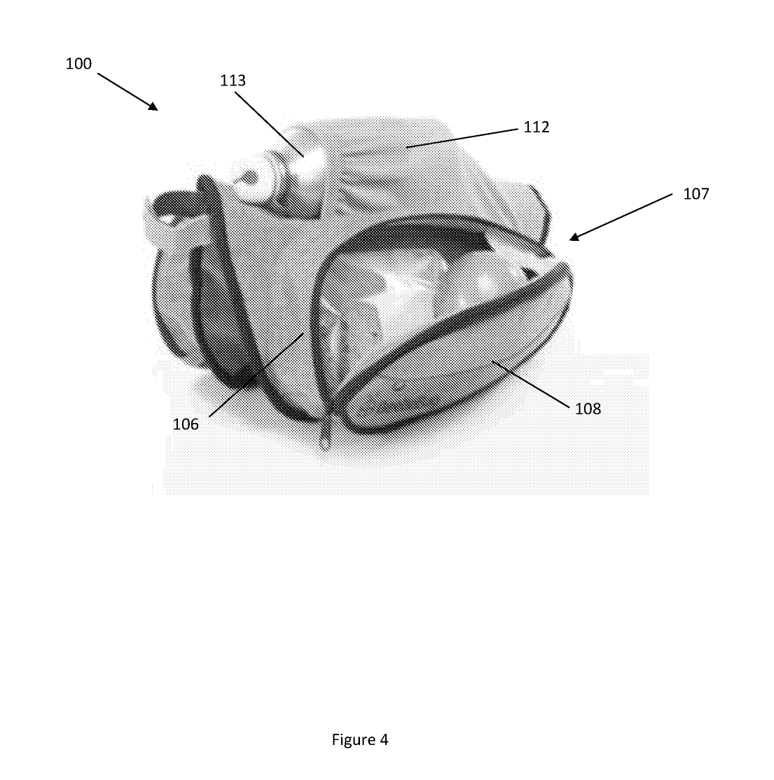

Reference is now also made to FIG. 4 which schematically illustrates a perspective view of bicycle bag 100 in the folded position, including storage compartments 106 for storing items 107, according to an embodiment of the present invention. Wing-shaped sections 101 may each include compartment 106 on an exterior side of the section which may be used to store different types of items 107, which may include clothing apparel, cosmetics, keys, water bottle (which may include other fluids), and computing devices including mobile phones, among numerous other items which a user may fit into the compartments. Compartments 106 may include a cover 108 to prevent the items stored inside from falling out. Cover 108 may be maintained closed by a closing mechanism 110 which may include, for example, a zipper mechanism, a hook and loop fastener, a snap-lock fastener, among many other suitable closing mechanisms known in the art. Placing compartments 106 on an external side of wing-shaped sections 101 not only may allow bag 100 to be used as a backpack, but may provide the additional benefit of allowing the rider to easily access the compartments and the items inside while riding on bicycle 10. In addition to compartments 106 in wing-shaped sections 101, central section 104 may include a pocket 112 to hold different types of accessories, for example, a water bottle 113. It may be appreciated by the skilled person that compartments 106 may each include one or more smaller compartments and that pocket 112 may include one or more pockets for storing other types of accessories (in addition to or alternatively to water bottle 113) and which may include a mobile phone, a GPS device, among other types of items.

Bicycle bag 100 may be of any suitable size to be mounted on top-tube 12 or on the bottom-tube and not interfere with a pedaling action of the rider. An exemplary size of bicycle bag 100 may be in a range from 25 cm-50 cm both in length and in width, with a width of each wing-shaped section 101 ranging from 10 cm-22 cm and substantially extending along the length of the bicycle bag. Compartments 106 may substantially occupy the whole area of each wing-shaped section 101 or be fitted within the size range of the wing-shaped section. As previously mentioned, compartments 106 may include one or more compartments, and each wing-shaped section 101 may have a different number of compartments. For example, one wing-shaped section may have one large compartment while the other wing-shaped section may have two or even three compartments. A curvature of rear section 103 may allow contour tracing of the translational path of the rider.

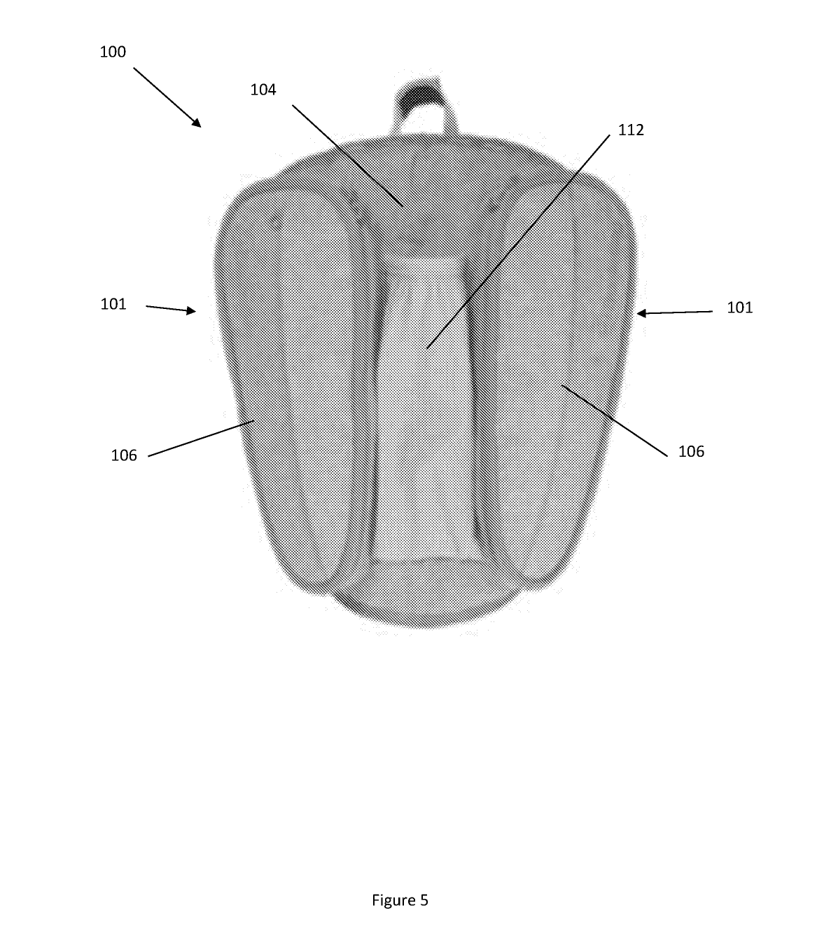

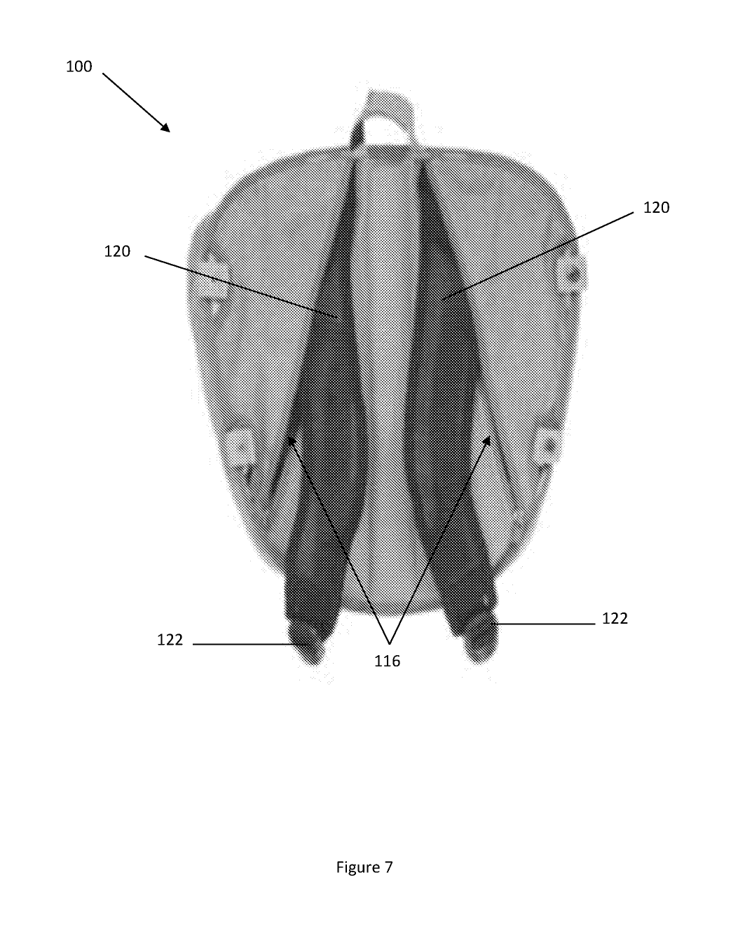

Reference is made to FIG. 5 which schematically illustrates a view of an upper side of bicycle bag 100 in the open position, and to FIG. 6 which schematically illustrates a view of an underside of the bag in the open position, according to an embodiment of the present invention. Reference is also made to FIG. 7 which schematically illustrates bicycle bag 100 in an exemplary backpack configuration, according to an embodiment of the present invention.

Bicycle bag 100 in the open position may be converted into, and worn as a backpack. As may be appreciated from FIG. 5, the upper side of bag 100 may include central section 104 with pocket 112 on the central section, and compartments 106 on wing-shaped sections 101. As may be appreciated from FIGS. 6 and 7, each wing-shaped section 101 may include in its underside a storage pocket 116 into which shoulder straps 120 may be inserted when bicycle bag 100 is mounted on top-tube, and which may be extracted from the storage pockets for wearing by the user when the bag is in the open position. Storage pockets 116 may include a closing mechanism 118 to keep the storage pockets closed and shoulder straps 120 inside when bicycle bag 100 is in the folded position. Closing mechanism 118 may include a zipper mechanism, a hook and loop fastener, a snap-lock fastener, among many other suitable closing mechanisms known in the art. Extracting both shoulder straps 120 from the wing-shaped sections may allow the user to wear bicycle bag 100 as a backpack, distributing the weight of the backpack on both shoulders. Alternatively, the user may choose to only extract one shoulder strap 120 for carrying the backpack on only one shoulder while leaving the second shoulder strap inside storage pocket 116. Shoulder straps 120 may include buckles 122 to allow the user to adjust a length of each shoulder strap.

In FIG. 6 may be viewed wing straps 114A and 114B used to attach wing-shaped sections 101 together when straddled over top-tube 12. Wing straps 114A and 114B are retractable into slots 119 on the underside of bicycle bag 100 when used as a backpack. When used as a bicycle bag, wing straps 114A and 114B may be extended outwards and may be fastened to one another.

Bicycle bag 100 may be made of any suitable material, or combination of materials, which may provide comfort to a wearer of the bag as a backpack. The materials may be lightweight materials and may be water resistant. Example of such a material may include a water resistant polyester material. Shoulder straps 122 may be made from a lightweight mesh material. Stitching where required may preferably include double reinforced seam stitching.

The foregoing description and illustrations of the embodiments of the invention has been presented for the purposes of illustration. It is not intended to be exhaustive or to limit the invention to the above description in any form. Any term that has been defined above and used in the claims, should to be interpreted according to this definition.

The reference numbers when included in the claims are not a part of the claims, but rather used for facilitating the reading thereof. These reference numbers should not be interpreted as limiting the claims in any form.

1. A bicycle bag suitable to be straddled over a structural tube of a bicycle in a folded position and convertible to a backpack in an open position.

2. A bicycle bag according to claim 1 comprising a first wing section, a second wing section, and an interconnecting central section joining said wing sections.

3. A bicycle bag according to claim 2 wherein at least one wing section comprises one or more storage compartments for storing items.

4. A bicycle bag according to claim 3 wherein said one or more storage compartments are located on an exterior side of the bicycle bag.

5. A bicycle bag according to claim 1 comprising a clasp to attach a forward section of the bicycle bag to a bicycle stem.

6. A bicycle bag according to claim 5 wherein said clasp is adjustable to allow adjusting a distance of the bag from said stem.

7. A bicycle bag according to claim 1 comprising at least one fastening mechanism to secure an underside of the bicycle bag to said structural tube.

8. A bicycle bag according to claim 7 wherein said fastening mechanism comprises at least one fastener strap.

9. A bicycle bag according to claim 8 wherein said fastener strap is elastic.

10. A bicycle bag according to claim 1 comprising slots on an underside of the bicycle bag to accommodate retractable fastening straps.

11. A bicycle bag according to claim 2 comprising at least one storage pocket on said central section.

12. A bicycle bag according to claim 11 wherein said at least one storage pocket accommodates any one of a drinking bottle, a mobile phone, and a GPS device.

13. A bicycle bag according to claim 1 comprising two storage pockets on an underside of the bag.

14. A bicycle bag according to claim 13 wherein said storage pockets each accommodate a shoulder strap.

15. A bicycle bag according to claim 1 comprising shoulder straps.

16. A bicycle bag according to claim 1 wherein said structural tube is a top-tube.

17. A bicycle bag according to claim 1 wherein said structural tube is a bottom- tube.
